(19) United States
(12) Patent Application Publication
(10) Pub. No.: US 2025/0373109 A1
(43) Pub. Date: Dec. 4, 2025

(54) INVERTER AND ELECTRIC COMPRESSOR

(71) Applicant: MITSUBISHI HEAVY INDUSTRIES ENGINE & TURBOCHARGER, LTD., Sagamihara-shi, Kanagawa (JP)

(72) Inventors: Takuma KONDO, Tokyo (JP); Hiroaki YAMATO, Tokyo (JP); Kyohei WATANABE, Tokyo (JP); Masato ITO, Tokyo (JP); Byeongil AN, Sagamihara-shi (JP); Makoto OGAWA, Sagamihara-shi (JP); Yuki YAKUWA, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 18/875,522

(22) PCT Filed: Jul. 5, 2022
(86) PCT No.: PCT/JP2022/026715

§ 371 Date: Dec. 16, 2024

(51) Int. Cl. H02K 3/50; B60H 1/32; H02K 5/20; H02K 11/33

(52) U.S. Cl. CPC H02K 3/50; H02K 5/203; H02K 11/33; B60H 2001/3292; H02K 2203/09; H02K 2203/15

(57) ABSTRACT

This inverter provides power to a motor of a motor unit, and comprises a substrate, a power semiconductor which is mounted on the substrate, a bus bar which has a first terminal that is mounted on the substrate and a second terminal that is on the opposite side to the first terminal, and a fixing part in which is fixed a fixing screw of the bus bar that couples a motor cable of the motor unit and the second terminal, wherein the fixing part is inserted in a through hole of the motor unit through which the motor cable passes.

### TECHNICAL FIELD

The present disclosure relates to an inverter and an electric compressor.

### BACKGROUND ART

PTL 1 discloses an electric compressor including an inverter, a motor driven by power supplied from the inverter, and a compression portion operated by the motor. The inverter includes a power module (a power semiconductor) for supplying power to the motor, and a substrate on which the power semiconductor is mounted. In the electric compressor of PTL 1, the inverter and the motor are electrically connected to each other by a connector.

### CITATION LIST

### Patent Literature

[PTL 1] Japanese Patent No. 6256382

### SUMMARY OF INVENTION

### Technical Problem

In a case where the inverter and the motor are connected to each other by wiring, there is a case where the inverter cannot be reduced in size with respect to the structure of the motor, based on the structure of the wiring.

The present disclosure has been made to solve the above problems, and an object of the present disclosure is to provide an inverter capable of being reduced in size and an electric compressor including the inverter.

### Solution to Problem

In order to solve the above problems, an inverter according to the present disclosure is an inverter that supplies power to a motor of a motor unit, the inverter including a substrate, a power semiconductor that is mounted on the substrate, a bus bar that has a first end mounted on the substrate and a second end on a side opposite to the first end, and a fixing unit to which a bus bar fixing screw that fastens a motor cable of the motor unit and the second end is fixed, in which the fixing unit is inserted into a through-hole of the motor unit through which the motor cable passes.

The electric compressor according to the present disclosure includes the inverter, the motor unit, and a compression portion that is connected to the motor.

### ADVANTAGEOUS EFFECTS OF INVENTION

According to the present disclosure, it is possible to reduce the size of the inverter.

### BRIEF DESCRIPTION OF DRAWINGS

FIG. 1 is a cross-sectional view of an electric compressor according to a first embodiment of the present disclosure.

FIG. 2 is a view of the electric compressor of FIG. 1 as seen from an upper surface side of a substrate in an axial direction of a rotary shaft.

FIG. 3 is a view illustrating main parts of an electric compressor according to a second embodiment of the present disclosure.

FIG. 4 is a diagram showing a step of manufacturing the electric compressor according to the second embodiment of the present disclosure.

FIG. 5 is a diagram showing a step following FIG. 4.

### DESCRIPTION OF EMBODIMENTS

### First Embodiment

### (Configuration of Electric Compressor)

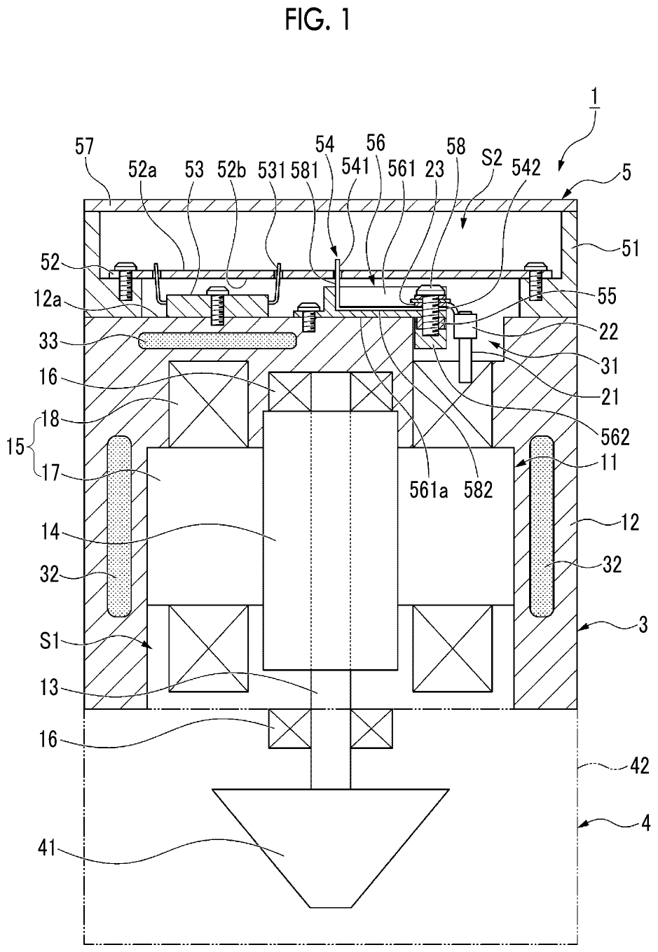

An electric compressor of the present embodiment is used, for example, in a vehicle-mounted air conditioner and is mounted in a vehicle or the like. As shown in FIG. 1, an electric compressor 1 includes a motor unit 3, a compression portion 4, and an inverter 5.

### (Motor Unit)

The motor unit 3 includes a motor 11 and a motor housing 12 having an accommodation space S1 (hereinafter, referred to as a first accommodation space S1) for accommodating the motor 11. The motor 11 includes a rotary shaft 13, a rotor 14, and a stator 15.

The rotary shaft 13 is mounted to the motor housing 12 so as to be rotatable via a bearing 16. The bearings 16 are attached to the motor housing 12 and a compression portion housing 42 to be described later on both sides of the rotor 14 in an axial direction of the rotary shaft 13 (motor 11). The rotor 14 is formed in a cylindrical shape around the rotary shaft 13 and is integrally fixed to the rotary shaft 13.

The stator 15 includes a stator core 17 having a cylindrical shape around the rotary shaft 13 and a coil 18 wound around teeth of the stator core 17. The stator 15 is disposed outside the rotor 14 in a radial direction of the rotary shaft 13. In addition, the stator 15 is fitted to an inside of a peripheral wall of the motor housing 12 formed in a cylindrical shape. The stator 15 is located outside the bearing 16 in the radial direction of the rotary shaft 13.

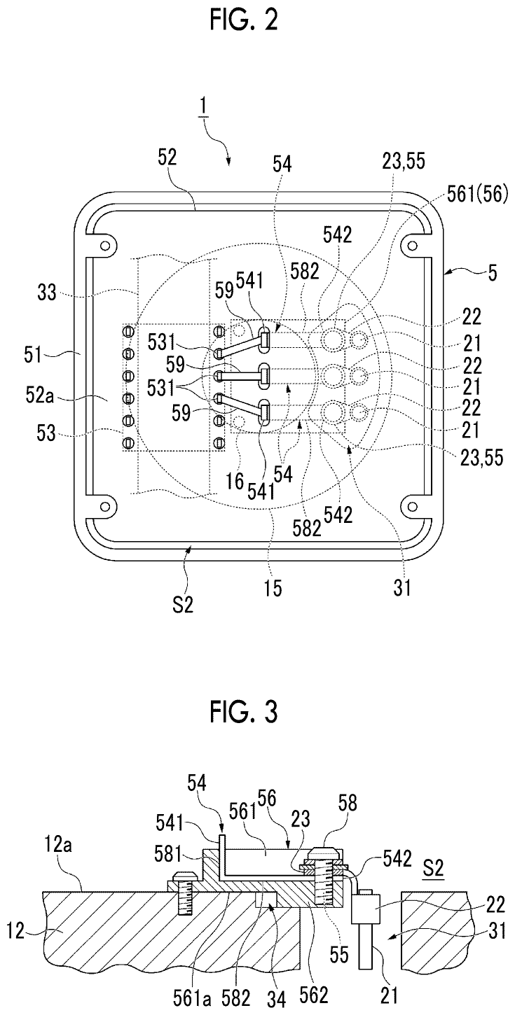

A motor cable 21 is connected to the coil 18. The motor cable 21 connects the coil 18 to the inverter 5 to supply power from the inverter 5 to the coil 18. The motor cable 21 mainly extends in the axial direction of the rotary shaft 13 from the coil 18. As shown in FIG. 2, the number of motor cables 21 in the present embodiment is three.

As illustrated in FIGS. 1 and 2, in the present embodiment, a tip portion of the motor cable 21 has a connection terminal 22 for connection to a bus bar 54 of the inverter 5 (to be described later). The connection terminal 22 of the present embodiment has an annular connecting portion 23. The annular connecting portion 23 is provided such that an axis thereof extends in the axial direction of the rotary shaft 13. The connection terminal 22 may be, for example, a pressure-welded terminal attached to the tip portion of the motor cable 21.

As illustrated in FIG. 1, a through-hole 31 for allowing the motor cable 21 to pass through in the axial direction of the rotary shaft 13 is formed in the motor housing 12. The through-hole 31 extends from the motor 11 up to the inverter 5 (to be described later). Specifically, the through-hole 31 extends in the axial direction of the rotary shaft 13 from the first accommodation space S1 of the motor housing 12 up to a second accommodation space S2 of an inverter housing 51 (to be described later). As illustrated in FIGS. 1 and 2, the through-hole 31 is located outside the bearing 16 and inside an outer periphery of the stator 15 when viewed in the axial direction of the rotary shaft 13. Specifically, the through-hole 31 is formed in a region that overlaps the stator 15 (particularly the coil 18) in the axial direction of the rotary shaft 13. In addition, the through-hole 31 is formed to correspond to a part in a circumferential direction of the stator 15 that has a cylindrical shape when viewed in the axial direction of the rotary shaft 13.

As illustrated in FIG. 1, a water-cooling jacket 32 for a motor that cools the motor 11 is provided in the motor housing 12. The water-cooling jacket 32 for a motor is a flow channel through which cooling water for cooling the motor 11 circulates, and is partitioned from the first accommodation space S1. In the present embodiment, the water-cooling jacket 32 for a motor is disposed outside (the peripheral wall of the motor housing 12) of the outer periphery of the stator 15.

### (Compression Portion)

The compression portion 4 is disposed adjacent to one side of the rotary shaft 13 in the axial direction with respect to the motor unit 3, and is connected to the motor 11. The compression portion 4 includes a compression portion body 41 and a compression portion housing 42. The compression portion body 41 is directly connected to the rotary shaft 13 of the motor 11 and rotates together with the rotary shaft 13 of the motor 11. The compression portion housing 42 is integrally provided in the motor housing 12. In the compression portion 4, the compression portion body 41 rotates, so that gas sucked into the compression portion housing 42 is compressed and then discharged to an outside of the compression portion housing 42. Air sucked into the compression portion housing 42 is prevented from entering the first accommodation space S1 of the motor housing 12.

### (Inverter)

The inverter 5 has a configuration for supplying power to the motor 11. The inverter 5 is disposed adjacent to the other side of the rotary shaft 13 in the axial direction with respect to the motor unit 3. That is, the inverter 5 is disposed such that the motor unit 3 is located between the inverter 5 and the compression portion 4 in the axial direction of the rotary shaft 13.

The inverter 5 includes the inverter housing 51, a substrate 52, a power semiconductor 53, the bus bar 54, a fixing unit 55, and a bus bar housing 56.

### (Inverter Housing)

The inverter housing 51 is integrally provided in the motor housing 12. The inverter housing 51 forms an accommodation space S2 (hereinafter, also referred to as a second accommodation space S2) for accommodating the components of the inverter 5 such as the substrate 52, the power semiconductor 53, and the bus bar 54, together with the motor housing 12. A part of the second accommodation space S2 is defined by an end surface 12a of the motor housing 12 positioned on the inverter 5 side. The through-hole 31 is open in the end surface 12a of the motor housing 12. Accordingly, the first accommodation space S1 of the motor housing 12 and the second accommodation space S2 of the inverter 5 are connected to each other by the through-hole 31.

The inverter housing 51 of the present embodiment is open on a side opposite (upper side in FIG. 1) to the motor housing 12 in the axial direction of the rotary shaft 13. The inverter housing 51 includes a cover portion 57 that closes an opening of the inverter housing 51 in an openable and closable manner.

### (Substrate)

The substrate 52 is disposed in the second accommodation space S2 such that a plate thickness direction thereof faces the axial direction of the rotary shaft 13. The substrate 52 is held by the motor housing 12 such that a gap is formed between the substrate 52 and the end surface 12a of the motor housing 12. The substrate 52 has a lower surface 52b facing the end surface 12a of the motor housing 12 and an upper surface 52a facing a side opposite to the lower surface 52b. The upper surface 52a of the substrate 52 faces an opening side of the inverter housing 51. A wiring pattern 59 (refer to FIG. 2) that constitutes a circuit of the inverter 5 is formed on the substrate 52.

### (Power Semiconductor)

The power semiconductor 53 is electrically connected to the coil 18 of the motor 11 to supply power to the coil 18. The power semiconductor 53 is mounted on the substrate 52. In the present embodiment, the power semiconductor 53 is mounted on the lower surface 52b of the substrate 52, that is, the power semiconductor 53 is disposed between the substrate 52 and the end surface 12a of the motor housing 12. In addition, the power semiconductor 53 is fixed to the end surface 12a of the motor housing 12 by screwing. In this manner, the power semiconductor 53 is held in a state of being in contact with the end surface 12a of the motor housing 12.

A terminal 531 of the power semiconductor 53 connected to the coil 18 is connected to the substrate 52 by soldering or the like. As illustrated in FIG. 2, the terminal 531 of the power semiconductor 53 is located in a region overlapping the bearing 16 when viewed in the axial direction of the rotary shaft 13. The power semiconductor 53 has three such terminals 531. The three terminals 531 are arranged in a row in a direction (up-down direction in FIG. 2) orthogonal to a direction (right-left direction in FIG. 2) in which the power semiconductor 53 and the through-hole 31 are arranged when viewed in the axial direction of the rotary shaft 13.

### (Water-Cooling Jacket for Semiconductor)

As illustrated in FIG. 1, the power semiconductor 53 of the present embodiment is cooled by the water-cooling jacket 33 for a semiconductor provided in the motor housing 12. The water-cooling jacket 33 for a semiconductor is a flow channel through which cooling water for cooling the power semiconductor 53 circulates. The water-cooling jacket 33 for a semiconductor is disposed between the first accommodation space S1 and the end surface 12a of the motor housing 12 in the axial direction of the rotary shaft 13. As illustrated in FIGS. 1 and 2, the water-cooling jacket 33 for a semiconductor is positioned at an interval from the through-hole 31 so as not to interfere with the through-hole 31.

### (Bus Bar)

The bus bar 54 is a band-shaped plate made of a conductive material, and includes a first end 541 that is mounted on the substrate 52, and a second end 542 that is located on a side opposite to the first end 541 and that is connected to the motor cable 21. The bus bar 54 constitutes connection wiring for electrically connecting the motor cable 21 and the power semiconductor 53. The first end 541 of the bus bar 54 is connected to the substrate 52 by soldering or the like.

As illustrated in FIG. 1, the bus bar 54 of the present embodiment is disposed between the substrate 52 and the end surface 12a of the motor housing 12, similarly to the power semiconductor 53. The bus bar 54 includes a first portion 581 that includes the first end 541 and that extends in the axial direction of the rotary shaft 13 from the substrate 52, and a second portion 582 that extends in a direction orthogonal to the axial direction of the rotary shaft 13 from a tip of the first portion 581. The bus bar 54 of the present embodiment is formed in an L shape. The second end 542 of the bus bar 54 is located at a tip portion of the second portion 582 extending from the first portion 581.

As illustrated in FIGS. 1 and 2, the first portion 581 of the bus bar 54 including the first end 541 is located in the region overlapping the bearing 16 when viewed in the axial direction of the rotary shaft 13, similarly to the terminal 531 of the power semiconductor 53. The second portion 582 of the bus bar 54 extends from a region overlapping with the bearing 16 up to a region not overlapping with the bearing 16 (hereinafter, referred to as a “region outside the bearing 16”) located outside the “region overlapping the bearing 16” when viewed in the axial direction of the rotary shaft 13. In addition, the second end 542 of the bus bar 54 is located in a region overlapping the through-hole 31 in the axial direction of the rotary shaft 13.

The “region outside the bearing 16” described above is a space outside the circular broken line 16 in the second accommodation space S2 as illustrated in FIG. 2, when viewed in the axial direction of the rotary shaft 13. In addition, the “region overlapping the bearing 16” is a space inside the circular broken line 16 in the second accommodation space S2 as illustrated in FIG. 2, when viewed in the axial direction of the rotary shaft 13.

As illustrated in FIG. 2, the bus bar 54 of the present embodiment is positioned between the power semiconductor 53 and the through-hole 31 when viewed in the axial direction of the motor 11. In other words, the power semiconductor 53, the bus bar 54, and the through-hole 31 are arranged in order in one direction (right-left direction in FIG. 2).

The number of the bus bars 54 is three, and corresponds to the number of the motor cables 21 and the number of the terminals 531 of the power semiconductors 53. The three bus bars 54 are arranged in a row in a direction in which the three terminals 531 of the power semiconductor 53 are arranged (up-down direction in FIG. 2) when viewed in the axial direction of the rotary shaft 13.

The above-described bus bar 54 and the terminal 531 of the power semiconductor 53 are connected to each other via the wiring pattern 59 formed on the substrate 52. The wiring pattern 59 constitutes a connection wire for electrically connecting the motor cable 21 and the power semiconductor 53 together with the bus bar 54.

### (Fixing Unit)

As illustrated in FIG. 1, the fixing unit 55 is a portion for connecting the motor cable 21 and the second end 542 of the bus bar 54. The motor cable 21 and a bus bar fixing screw 58 for fastening the second end 542 of the bus bar 54 are fixed to the fixing unit 55. The fixing unit 55 is a female thread for the bus bar fixing screw 58 to be screwed into. The fixing unit 55 of the present embodiment is a nut having the female thread. The fixing unit 55 that is a nut is disposed such that the axial direction of the female thread faces the axial direction of the rotary shaft 13.

As shown in FIG. 2, the number of the fixing units 55 is three, and corresponds to the number of the motor cables 21 and the number of the bus bars 54. The three fixing units 55 are arranged in a row in a direction (up-down direction in FIG. 2) in which the bus bars 54 are arranged.

As shown in FIG. 1, the fixing unit 55 is inserted into the through-hole 31 of the motor housing 12. For this reason, as illustrated in FIG. 2, the fixing unit 55 is located outside the bearing 16 and inside the outer periphery of the stator 15, when viewed in the axial direction of the rotary shaft 13, similarly to the through-hole 31.

### (Bus Bar Housing)

As illustrated in FIG. 1, the bus bar housing 56 has an electrical insulating property and holds the bus bar 54 and the fixing unit 55. The bus bar housing 56 includes a housing main body 561 and an insertion part 562.

The housing main body 561 holds the three bus bars 54. The housing main body 561 is positioned between the substrate 52 and the end surface 12a of the motor housing 12. Specifically, the housing main body 561 is placed on the end surface 12a of the motor housing 12. The housing main body 561 has a contact surface 561a that is in surface-contact with the end surface 12a of the motor housing 12.

The insertion part 562 holds the three fixing units 55. The insertion part 562 is integrally formed on the housing main body 561. Each of the fixing units 55 held by the insertion part 562 is positioned to overlap the second end 542 of each bus bar 54 held by the housing main body 561, on the motor 11 side. The insertion part 562 protrudes from the contact surface 561a of the housing main body 561. The insertion part 562 is inserted into the through-hole 31 together with the fixing unit 55 in a state where the housing main body 561 is placed on the end surface 12a of the motor housing 12.

The bus bar housing 56 disposed as described above is fixed to the motor housing 12 by screwing. In this manner, the three bus bars 54 and the three fixing units 55 are collectively positioned.

In the present embodiment, the motor cable 21 and the bus bar 54 are fastened to each other by fixing the bus bar fixing screw 58 to the fixing unit 55 after passing the bus bar fixing screw 58 through the connecting portion 23 of the connection terminal 22 provided at the tip portion of the motor cable 21. Accordingly, the motor cable 21 and the bus bar 54 are electrically connected to each other.

In the electric compressor 1 configured as described above, the power semiconductor 53 and the coil 18 of the motor 11 are electrically connected to each other via the motor cable 21, the bus bar 54, and the wiring pattern 59 of the substrate 52.

### (Method for Manufacturing Electric Compressor)

In the manufacturing of the electric compressor 1 of the present embodiment, the motor 11 is inserted into the first accommodation space S1 of the motor housing 12 from the compression portion 4 side. Accordingly, the motor cable 21 can be inserted into the through-hole 31.

In addition, the insertion part 562 of the bus bar housing 56 is inserted into the through-hole 31, the housing main body 561 is placed on the end surface 12a of the motor housing 12, and the bus bar housing 56 is fixed to the motor housing 12 by screwing. Accordingly, the bus bar 54 is disposed on the end surface 12a of the motor housing 12, and the fixing unit 55 is inserted into the through-hole 31. The fixing of the bus bar housing 56 may be performed either before or after the motor cable 21 is inserted into the through-hole 31.

Thereafter, the bus bar fixing screw 58 is fixed to the fixing unit 55 in a state where the connecting portion 23 of the connection terminal 22 of the motor cable 21 is overlapped with the upper side of the fixing unit 55 inserted into the through-hole 31. In this manner, the motor cable 21 and the second end 542 of the bus bar 54 are fastened.

In addition, the power semiconductor 53 is fixed to the end surface 12a of the motor housing 12. The fixing of the power semiconductor 53 may be performed before or after the above-described step or at the same time as the above-described step.

After all the above-described steps, the substrate 52 is disposed on the upper side of the power semiconductor 53, the bus bar 54, the fixing unit 55, and the bus bar housing 56. In the present embodiment, the substrate 52 is disposed, so that the terminal 531 of the power semiconductor 53 and the first end 541 of the bus bar 54 are inserted into the substrate 52 and protrude to the upper surface 52a side of the substrate 52. Then, the terminal 531 of the power semiconductor 53 and the first end 541 of the bus bar 54 are connected to the substrate 52 by soldering or the like. Accordingly, the power semiconductor 53 and the coil 18 of the motor 11 are electrically connected to each other via the motor cable 21, the bus bar 54, and the wiring pattern 59 of the substrate 52. After the power semiconductor 53 and the coil 18 of the motor 11 are electrically connected to each other, the opening of the inverter housing 51 may be closed by the cover portion 57.

In the electric compressor 1 and the inverter 5 of the present embodiment, the fixing unit 55 for fastening the motor cable 21 and the second end 542 of the bus bar 54 is inserted into the through-hole 31 of the motor housing 12. Therefore, the dimension of the inverter 5 in the axial direction of the rotary shaft 13 can be suppressed to be smaller than in a case where the fixing unit 55 is disposed on the end surface 12a of the motor housing 12. That is, the size of the inverter 5 located outside the motor unit 3 can be reduced. Therefore, it is possible to reduce the size of the inverter 5 and the electric compressor 1 including the inverter 5.

In addition, in the electric compressor 1 and the inverter 5 of the present embodiment, the bus bar 54 is used for the connection between the power semiconductor 53 and the motor cable 21. For this reason, the length of the wiring pattern 59 of the substrate 52 required for the connection between the power semiconductor 53 and the motor cable 21 can be set to be short. Accordingly, the formation region of the wiring pattern 59 in the substrate 52 can be reduced, and the region of the substrate 52 can be effectively utilized as a mounting region of the other electrical/electronic components (for example, a capacitor constituting the inverter 5). Accordingly, the substrate 52 can be downsized, and as a result, the inverter 5 and the electric compressor 1 including the inverter 5 can be further downsized.

In addition, in the electric compressor 1 and the inverter 5 of the present embodiment, the bus bar 54 and the fixing unit 55 are held by the bus bar housing 56. For this reason, when the bus bar 54 is connected to the motor cable 21, it is not necessary to relatively position the bus bar 54 and the fixing unit 55. Therefore, the bus bar 54 and the motor cable 21 can be easily connected to each other.

In addition, since a plurality of bus bars 54 are held by the bus bar housing 56, the plurality of bus bars 54 can be easily relatively positioned. Similarly, the relative positioning of a plurality of fixing units 55 can be easily performed.

In addition, in the electric compressor 1 and the inverter 5 of the present embodiment, the bus bar 54 extends from a region overlapping the bearing 16 up to a region outside the bearing 16 when viewed in the axial direction of the rotary shaft 13. Therefore, even when the first end 541 of the bus bar 54 is positioned in the region overlapping the bearing 16, the second end 542 of the bus bar 54 can be disposed in the region outside the bearing 16. Accordingly, the through-hole 31 through which the motor cable 21 passes can be disposed in the region outside the bearing 16. By disposing the through-hole 31 in the region outside the bearing 16, when the motor 11 is moved in the axial direction of the rotary shaft 13 and inserted into the motor housing 12, the motor cable 21 is prevented from interfering with the bearing 16 provided in the motor housing 12, and thus the bus bar 54 and the motor cable 21 can be easily connected to each other.

In addition, in the electric compressor 1 and the inverter 5 of the present embodiment, the fixing unit 55 is located outside the bearing 16 of the motor unit 3 and inside the outer periphery of the stator 15 when viewed in the axial direction of the rotary shaft 13. For this reason, the through-hole 31 through which the motor cable 21 passes can be disposed outside the bearing 16 and inside the outer periphery of the stator 15. Accordingly, when the motor 11 is moved in the axial direction of the rotary shaft 13 and inserted into the motor housing 12, the motor cable 21 is prevented from interfering with the motor housing 12 (particularly, a portion provided with the water-cooling jacket 32 for a motor) or the bearing 16 provided in the motor housing 12, and the bus bar 54 and the motor cable 21 can be easily connected to each other.

In addition, the electric compressor 1 of the present embodiment is provided with the water-cooling jacket 32 for a motor that cools the motor 11 inside the motor housing 12. Accordingly, even when the through-hole 31 through which the first accommodation space S1 of the motor housing 12 and the inverter 5 are connected to each other is formed in the motor housing 12, the motor 11 accommodated in the first accommodation space S1 can be cooled by the water-cooling jacket 32 for a motor. Hereinafter, this point will be described.

In a case where the through-hole 31 is not formed in the motor housing 12, the gas compressed in the compression portion 4 can circulate into the first accommodation space S1 of the motor housing 12. In this case, the motor 11 can be cooled by the gas. However, it is not preferable that the gas flows into the inverter 5. For this reason, in the electric compressor 1 of the present embodiment in which the first accommodation space S1 of the motor housing 12 and the second accommodation space S2 of the inverter 5 are connected to each other by the through-hole 31, the gas cannot circulate into the first accommodation space S1. In contrast, in the electric compressor 1 of the present embodiment, the water-cooling jacket is provided in the motor housing 12. Accordingly, even when the first accommodation space S1 of the motor housing 12 and the second accommodation space S2 of the inverter 5 are connected to each other, the motor 11 can be cooled by the water-cooling jacket 32 for a motor.

In addition, in the electric compressor 1 of the present embodiment, the bus bar 54 electrically connecting the power semiconductor 53 and the motor cable 21 extends from the through-hole 31 toward the power semiconductor 53 in the direction orthogonal to the axial direction of the rotary shaft 13. For this reason, the power semiconductor 53 can be positioned away from the through-hole 31. Accordingly, even when the water-cooling jacket 33 for a semiconductor that cools the power semiconductor 53 is provided in the motor housing 12, the water-cooling jacket 33 for a semiconductor can be disposed close to the power semiconductor 53 without interfering with the through-hole 31. As a result, the water channel width of the water-cooling jacket 33 for a semiconductor can be sufficiently secured on a lower surface side of the power semiconductor 53 that comes into contact with the end surface 12a of the motor housing 12. Therefore, the power semiconductor 53 can be efficiently cooled.

In addition, in the electric compressor 1 of the present embodiment, the through-hole 31 extends from the motor 11 to the inverter 5. Accordingly, the motor cable 21 is passed through the through-hole 31, so that the motor cable 21 can reliably reach from the motor 11 to the fixing unit 55 of the inverter 5.

In addition, in the electric compressor 1 of the present embodiment, the power semiconductor 53, the bus bar 54, and the through-hole 31 are arranged in order in one direction when viewed in the axial direction of the rotary shaft 13. For this reason, it is possible to suppress or prevent an increase in the length of the connection wire extending from the power semiconductor 53 up to the through-hole 31 (the length of the bus bar 54 and the length of the wiring pattern 59 of the substrate 52). This effect is useful in a case where the bus bar 54 that connects the power semiconductor 53 and the motor 11 or the wiring pattern 59 of the substrate 52 is plural in number as in the present embodiment. Hereinafter, this point will be described.

In a case where the power semiconductor 53, the bus bar 54, and the through-hole 31 are not arranged in a row, some of the plurality of bus bars 54 become longer than the other bus bars 54. On the other hand, in a case where the power semiconductor 53, the bus bar 54, and the through-hole 31 are arranged in a row as in the present embodiment, it is possible to suppress or prevent a difference in the length of the bus bar 54 between the plurality of bus bars 54. The same applies to the wiring pattern 59 of the substrate 52 that connects the power semiconductor 53 and the motor cable 21.

In the first embodiment, the fixing unit 55 may be integrally formed with, for example, the bus bar housing 56. That is, the fixing unit 55 may be, for example, a female thread directly formed in the bus bar housing 56. In addition, the fixing unit 55 (female thread) may be formed in the bus bar housing 56 by, for example, mounting the bus bar fixing screw 58, which is a tapping screw, to the bus bar housing 56.

The configuration in which the fixing unit 55 is integrally formed with the bus bar housing 56 as described above is included in the configuration in which the fixing unit 55 is held by the bus bar housing 56.

### Second Embodiment

Next, an electric compressor of a second embodiment will be described with reference to FIGS. 3 to 5. In the following description, the same configurations as those already described will be denoted by the same reference numerals, and redundant description thereof will be omitted.

As illustrated in FIG. 3, the motor housing 12 that constitutes the electric compressor of the second embodiment is provided with the through-hole 31 that is open to the end surface 12a of the motor housing 12 and through which the motor cable 21 passes, as in the first embodiment. The connecting portion 23 of the connection terminal 22 forming the tip portion of the motor cable 21 is disposed at a position protruding from the end surface 12a of the motor housing 12.

In the second embodiment, a counterbore 34 is formed in the motor housing 12 so as to be recessed from the end surface 12a. The counterbore 34 is adjacent to the through-hole 31 along the end surface 12a of the motor housing 12 and communicates with the through-hole 31. The dimensions of the counterbore 34 are set such that a part or all of the insertion part 562 of the bus bar housing 56 inserted into the through-hole 31 can be accommodated in the counterbore 34.

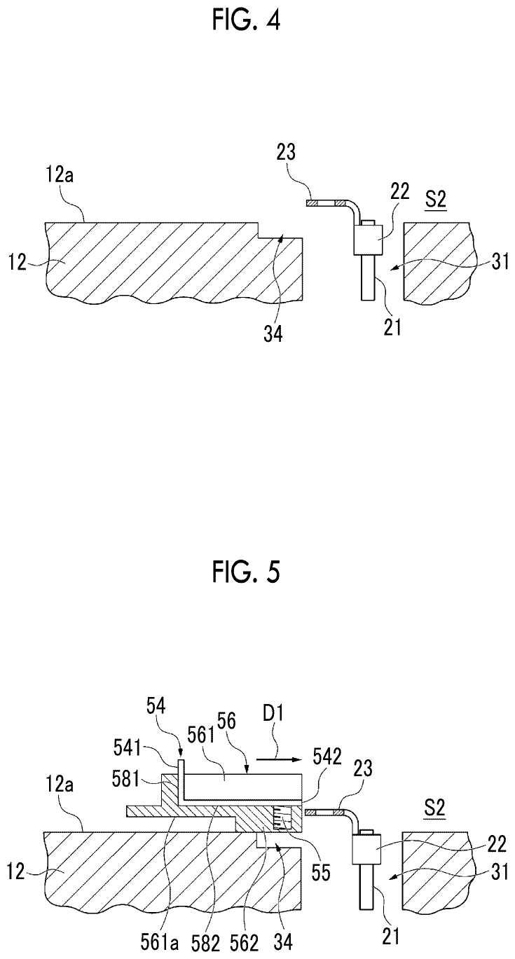

When the electric compressor of the second embodiment is manufactured, as in the first embodiment, the motor 11 is inserted into the first accommodation space S1 (refer to FIG. 1) of the motor housing 12, so that the motor cable 21 can be inserted into the through-hole 31 as illustrated in FIG. 4. When the motor cable 21 is inserted into the through-hole 31, the connecting portion 23 of the connection terminal 22 is disposed at a position protruding from the end surface 12a of the motor housing 12. The connecting portion 23 is located on the through-hole 31 and is not located on the counterbore 34.

Next, as shown in FIG. 5, the bus bar housing 56 in which the bus bar 54 and the fixing unit 55 are held is disposed in a region of the end surface 12a of the motor housing 12 where the counterbore 34 is positioned between the end surface 12a and the through-hole 31. In FIG. 5, the bus bar housing 56 is disposed in a region on a left side of the counterbore 34 on the end surface 12a of the motor housing 12. In addition, the bus bar housing 56 is positioned such that the insertion part 562 of the bus bar housing 56 is located on a side close to the counterbore 34.

Thereafter, the bus bar housing 56 is slid in a direction (direction D1 in FIG. 5) approaching the counterbore 34 along the end surface 12a of the motor housing 12. Accordingly, the insertion part 562 of the bus bar housing 56 is inserted into the counterbore 34, and the contact surface 561a of the housing main body 561 is brought into surface-contact with the end surface 12a of the motor housing 12. Then, when the bus bar housing 56 is further slid in the direction D1, as shown in FIG. 3, the insertion part 562 including the fixing unit 55 enters a lower side of the connecting portion 23 of the connection terminal 22.

Thereafter, as in the first embodiment, the motor cable 21 and the second end 542 of the bus bar 54 may be fastened to each other by fixing the bus bar fixing screw 58 to the fixing unit 55. In addition, the bus bar housing 56 may be fixed to the motor housing 12 by screwing.

According to the second embodiment, the same effects as those of the first embodiment can be obtained.

In addition, according to the second embodiment, the motor housing 12 is formed with the counterbore 34 that is recessed from the end surface 12a of the motor housing 12 and that communicates with the through-hole 31 along the end surface 12a of the motor housing 12. Accordingly, the bus bar housing 56 in which the bus bar 54 and the fixing unit 55 are held can be easily disposed at a predetermined position after the motor cable 21 in which the connection terminal 22 is provided at the tip portion is passed through the through-hole 31. Specifically, the insertion part 562 of the bus bar housing 56 including the fixing unit 55 can be easily made to enter below the connecting portion 23 of the connection terminal 22.

The embodiments of the present disclosure have been described in detail with reference to the drawings. However, the specific configurations are not limited to the embodiments, and the present disclosure includes design changes or the like within the scope not departing from the gist of the present disclosure.

In the present disclosure, the motor cable 21 may not have, for example, the connection terminal 22, and may be directly fastened to the second end 542 of the bus bar 54 by screwing.

### Additional Notes

The inverter 5 and the electric compressor 1 described in the above embodiment are understood as follows, for example.

(1) The inverter 5 according to a first aspect is the inverter 5 that supplies power to the motor 11 of the motor unit 3, the inverter 5 including the substrate 52, the power semiconductor 53 that is mounted on the substrate 52, the bus bar 54 that has the first end 541 mounted on the substrate 52 and the second end 542 on a side opposite to the first end 541, and the fixing unit 55 to which the bus bar fixing screw 58 that fastens the motor cable 21 of the motor unit 3 and the second end 542 is fixed, in which the fixing unit 55 is inserted into the through-hole 31 of the motor unit 3 through which the motor cable 21 passes.

According to the above configuration, the fixing unit 55 of the inverter 5 that connects the motor cable 21 and the bus bar 54 enters the through-hole 31 of the motor unit 3, and thereby the size of the inverter 5 (the size of the inverter 5 positioned outside the motor unit 3) can be reduced. That is, the inverter 5 can be reduced in size.

(2) The inverter 5 according to a second aspect is the inverter 5 according to (1), the inverter 5 further including the bus bar housing 56 that holds the bus bar 54 and the fixing unit 55.

In the above configuration, the bus bar 54 and the fixing unit 55 are held by the bus bar housing 56, so that the relative positioning between the bus bar 54 and the fixing unit 55 is not required when the bus bar 54 is connected to the motor cable 21. Therefore, the bus bar 54 and the motor cable 21 can be easily connected to each other.

(3) The inverter 5 according to a third aspect is the inverter 5 according to (1) or (2), in which the bus bar 54 extends from a region overlapping the bearing 16 of the motor unit 3 up to a region outside the bearing 16, when viewed in an axial direction of the motor 11.

In the above configuration, even when the first end 541 of the bus bar 54 is positioned in the region overlapping the bearing 16, the second end 542 of the bus bar 54 can be disposed in the region outside the bearing 16. Accordingly, the through-hole 31 through which the motor cable 21 passes can be disposed in the region outside the bearing 16. By disposing the through-hole 31 in the region outside the bearing 16, when the motor 11 is moved in the axial direction of the rotary shaft 13 and inserted into the motor housing 12, the motor cable 21 is prevented from interfering with the bearing 16 provided in the motor housing 12, and thus the bus bar 54 and the motor cable 21 can be easily connected to each other.

(4) The inverter 5 according to a fourth aspect is the inverter 5 according to any one of (1) to (3), in which the fixing unit 55 is located outside the bearing 16 of the motor unit 3 and inside the outer periphery of the stator 15 of the motor 11, when viewed in an axial direction of the motor 11.

In the above configuration, the through-hole 31 through which the motor cable 21 passes can be disposed outside the bearing 16 and inside the outer periphery of the stator 15. Accordingly, when the motor 11 is moved in the axial direction thereof and inserted into the motor housing 12, the motor cable 21 is prevented from interfering with the motor housing 12 or the bearing 16 attached to the motor housing 12, and the bus bar 54 and the motor cable 21 can be easily connected to each other.

(5) The electric compressor 1 according to a fifth aspect is the electric compressor 1 including the inverter 5 according to any one of (1) to (4), the motor unit 3, and the compression portion 4 that is connected to the motor 11.

In the above configuration, since the electric compressor 1 includes the inverter 5 that can reduce the size of the electric compressor 1, the electric compressor 1 can be reduced in size.

(6) The electric compressor 1 according to a sixth aspect is the electric compressor 1 according to (5), in which the motor unit 3 has the motor housing 12 that accommodates the motor 11, and the water-cooling jacket 32 for a motor that cools the motor 11 is provided in the motor housing 12.

In the above configuration, even when the through-hole 31 connecting the accommodation space of the motor housing 12 in which the motor 11 is accommodated and the inverter 5 is formed in the motor housing 12, the motor 11 can be cooled.

(7) The electric compressor 1 according to a seventh aspect is the electric compressor 1 according to (5) or (6), in which the motor unit 3 has the motor housing 12 that accommodates the motor 11, and the water-cooling jacket 33 for a semiconductor that cools the power semiconductor 53 is provided in the motor housing 12.

In the electric compressor 1 described above, the bus bar 54 electrically connecting the power semiconductor 53 and the motor cable 21 is extended from the through-hole 31 in a direction orthogonal to the axial direction of the motor 11, so that the power semiconductor 53 can be positioned away from the through-hole 31. For this reason, the water-cooling jacket 33 for a semiconductor can be disposed close to the power semiconductor 53 without interfering with the through-hole 31. Accordingly, the water channel width of the water-cooling jacket 33 for a semiconductor can be sufficiently secured on the lower surface side of the power semiconductor 53 that comes into contact with the motor housing 12. Therefore, the power semiconductor 53 can be efficiently cooled.

(8) The electric compressor 1 according to an eighth aspect is the electric compressor 1 according to any one of (5) to (7), in which the through-hole 31 extends from the motor 11 to the inverter 5.

In the above configuration, the motor cable 21 is passed through the through-hole 31, so that the motor cable 21 can reliably reach from the motor 11 to the fixing unit 55 which is a component of the inverter 5.

(9) The electric compressor 1 according to the ninth aspect is the electric compressor 1 according to any one of (5) to (8), in which the power semiconductor 53, the bus bar 54, and the through-hole 31 are arranged in order in one direction when viewed in the axial direction of the motor 11.

In the above configuration, it is possible to suppress or prevent an increase in the length of the connection wire extending from the power semiconductor 53 up to the through-hole 31 (the length of the bus bar 54 and the length of the wiring pattern 59 of the substrate 52).

### REFERENCE SIGNS LIST

1: electric compressor
3: motor unit
4: compression portion
5: inverter
11: motor
16: bearing
21: motor cable
31: through-hole
32: water-cooling jacket for a motor
33: water-cooling jacket for a semiconductor
52: substrate
53: power semiconductor
54: bus bar
541: first end of bus bar 54
542: second end of bus bar 54
55: fixing unit
56: bus bar housing
58: bus bar fixing screw

1. An inverter that supplies power to a motor of a motor unit, comprising:
a substrate;
a power semiconductor that is mounted on the substrate;
a bus bar that has a first end mounted on the substrate and a second end on a side opposite to the first end; and
a fixing unit to which a bus bar fixing screw that fastens a motor cable of the motor unit and the second end is fixed,
wherein the fixing unit is inserted into a through-hole of the motor unit through which the motor cable passes.

2. The inverter according to claim 1, further comprising a bus bar housing that holds the bus bar and the fixing unit.

3. The inverter according to claim 1,
wherein the bus bar extends from a region overlapping a bearing of the motor unit up to a region outside the bearing, when viewed in an axial direction of the motor.

4. The inverter according to claim 1,
wherein the fixing unit is located outside a bearing of the motor unit and inside an outer periphery of a stator of the motor, when viewed in an axial direction of the motor.

5. An electric compressor comprising:
the inverter according to claim 1;
the motor unit; and
a compression portion that is connected to the motor.

6. The electric compressor according to claim 5,
wherein the motor unit has a motor housing that accommodates the motor, and
a water-cooling jacket for a motor that cools the motor is provided in the motor housing.

7. The electric compressor according to claim 5,
wherein the motor unit has a motor housing that accommodates the motor, and
a water-cooling jacket for a semiconductor that cools the power semiconductor is provided in the motor housing.

8. The electric compressor according to claim 5,
wherein the through-hole extends from the motor up to the inverter.

9. The electric compressor according to claim 5,
wherein the power semiconductor, the bus bar, and the through-hole are arranged in order in one direction, when viewed in an axial direction of the motor.
